(19) United States
(12) Patent Application Publication
(10) Pub. No.: US 2020/0019143 A1
(43) Pub. Date: Jan. 16, 2020

(54) Packaging Plant Data Exchange and Method for Operating a Packaging Plant Data Exchange

(71) Applicant: SIG Technology AG, Neuhausen am Rheinfall (CH)

(72) Inventors: Matthias Eickhoff, Alsdorf (DE); Peter Holzkämper, Baesweiler (DE)

(21) Appl. No.: 16/485,881

(22) PCT Filed: Jan. 11, 2018
(86) PCT No.: PCT/EP2018/050604

§ 371 Date: Aug. 14, 2019

(30) Foreign Application Priority Data
Feb. 15, 2017 (DE) 10 2017 103 018.2

(51) Int. Cl. G05B 19/418; G06F 13/40; G06F 16/907; G06F 16/9035; G06F 9/54

(52) U.S. Cl. CPC G05B 19/418; G06F 13/4022; G05B 2219/45048; G06F 16/9035; G06F 9/544; G06F 16/907

(57) ABSTRACT

Packaging plant data exchange comprising at least one buffer for packaging plant status data comprising status values, at least one data input interface, the data input interface communicating with at least one program module adapted to a packaging device of the packaging plant and receiving at least packaging plant status data, at least one data storage interface, the data storage interface communicating with at least one database module adapted to a database.

The subject matter relates to a packaging plant data exchange, a method for operating a packaging plant data exchange, a computer program and a server for a packaging plant data exchange.

There are packaging plants in which a large number of different equipment and components are frequently used, such as filling machines, applicators for applying closures and/or straws, switches, case packers and cartoners. These facilities mostly originate from different manufacturers and provide packaging plant data such as packaging plant condition data representative of the condition of the respective facilities in different data formats for processing by a packaging plant data exchange and/or other facilities/components of the packaging plant. Also, facilities of different manufacturers provide different packaging machine data sets.

A problem with these packaging plants is therefore that the packaging plant data provided by the equipment of the packaging plant cannot be processed and evaluated uniformly due to the different data formats, so that individual solutions for processing and evaluation of the packaging plant data must be developed for each packaging plant.

Packaging plants are also frequently subsequently expanded, so that the solutions for processing and evaluation of the packaging plant data also have to be expanded and adapted accordingly.

Therefore, the object was to provide a flexible data management for packaging plants, which can be easily adapted to different machine interfaces of different packaging equipment and components.

This object is solved by means of a packaging plant data exchange device according to claim 1. In addition, the object is solved by a method according to claim 17, a computer program according to claim 20 and a system according to claim 21.

As already described above, a packaging plant can be understood as a system for packaging goods such as foodstuffs. In particular, a packaging plant may be understood as a beverage filling line and/or a part of a beverage filling line. Such systems often use a variety of different components such as filling machines, applicators for applying closures and/or drinking straws, switches, case packers and cartoners. Various applications run on these devices (e.g. in the form of a computer program executed by a processor of this component). The various components and applications of the packaging plant provide packaging plant data (in particular packaging plant condition data, condition data or status values of parameters of the packaging plant) in various data formats and/or via various machine interfaces for processing by a packaging plant data exchange and/or other equipment and/or applications. The information exchanged with the machine interfaces can then be processed with software interfaces as described below.

From practical experience, cardboard/plastic/metal composite packages are known to be used for various flowable or pourable products. The main area of application for such carton/plastic/metal composite packs is the packaging of beverages and heat-treated, in particular pasteurised foodstuffs. The well-known packings and packages are available in different shapes. These are typically rectangular, cubic and cylindrical. A major difference still exists, for example, with regard to the packing head, which is predominantly designed as a so-called flat gable or slanted gable.

Packages can be produced in different ways and from different materials. A widely used way of manufacturing them is to make a blank from the packaging material, from which, by folding and other steps, a pack sleeve is first produced and one end of which can be sealed. The pack can then be filled through the still at least partially open part of the pack sleeve. In some of these processes, a pack blank is formed onto a mandrel of a mandrel wheel.

One of the advantages of this production method is that the blanks and pack sleeves are very flat and can therefore be stacked to save space. In this way, the blanks or sleeves can be produced at a different location from that at which the sleeves are folded and filled. Composites are often used as a material, for example a composite of several thin layers of paper, cardboard, plastic or metal, especially aluminum. Such packaging is widely used in the food industry in particular.

A packaging plant data exchange can be understood, for example, as a function provided by a server device or a server system (e.g. the present server device or the present server system, which can be formed both virtually and directly) for switching packaging plant status data (packaging plant parameters and/or status data or status values) between different applications and/or devices/components of a packaging plant. For example, packaging plant data exchange is provided by a computer program (e.g. the present computer program) executed by at least parts of a processor of the server device or system. For example, the computer program is a middleware program and/or a service layer program.

For example, a buffer of the packaging plant data exchange contains only a limited number of status values for different states of the packaging plant. For example, a buffer memory of the packaging plant data exchange only contains current status values for different statuses of the packaging plant.

It goes without saying that an intermediate storage of the packaging plant data exchange in embodiments can also include a limited number of historical status values for the different states of the packaging plant in addition to the current status values for different states of the packaging plant. The status value of a status date or variable can be different at different times. It is possible to store a current status value and, if necessary, historical status values for a variable or a status date. Status values can be provided with a time stamp, so that a temporal assignment of a status value is possible and a temporal sequence of status values of a status date can be reconstructed.

For example, the buffer serves as a cache to prevent the packaging plant data exchange from having to access the persistent memory to access each status value. The buffer can also serve as a cache to buffer downtime in the persistent data store. The buffer memory can bridge downtimes between the packaging plant data exchange and the persistent memory. In particular, the buffer memory is formed as a bidirectional memory that enables both read and write access.

For example, the buffer of the packaging plant data exchange is part of a memory (e.g. a program and/or main memory) of the server device providing the packaging plant data exchange or of the virtual server providing the packaging plant data exchange.

The packaging plant data exchange, in particular a program module, implements at least one instance of a data input interface for at least indirect communication with devices/components and/or applications of the packaging plant via the program module. When we talk about a data input interface, reference can be made to an instance of a data input interface. In particular, a program module or an instance of a program module can provide methods for instantiating instances of data input interfaces, or a program module can provide a method as a data input interface.

It is understood that the packaging plant data exchange can at least indirectly communicate via the data input interface with a program module of other equipment/components and/or applications of the packaging plant (e.g. receive data from the other components and/or applications of the packaging plant and/or send error and/or confirmation notifications and/or commands to other components and/or applications of the packaging plant). If in the following we are talking about a program module, this can also be understood as an instance of a program module.

The communication takes place when a packaging device or components and/or application of the packaging machine communicates via the data input interface using a program module (e.g. a plug-in).

A program module can, for example, be adapted to the equipment/component and/or application of the packaging plant. For example, a program module is set up to prepare and/or convert data received from the equipment/component and/or application of the packaging plant (e.g. convert to a specified data format) and then output it via the data input interface or communicate it via the data input interface. Alternatively or additionally, such a program module is set up, for example, to prepare, process and/or convert confirmation and/or error notifications received via the data input interface (e.g. to convert them into a specified data format) and then, if necessary, forward them to the device/component and/or application of the packaging plant.

Two things can be achieved by adapting a program module to a particular component or packaging device. On the one hand, the program module can communicate via a standardized data input interface. This data input interface can be implemented identically for all types of program modules. In particular, each program module can provide an implementation of a data input interface. Packaging plant data exchange can provide the data input interface as a function, method and/or class. An instance of a program module can use a data input interface for communication.

On the other hand, a program module can be configured for one application purpose at a time. It was recognized that different packaging equipment/components provide their data in very different ways via partly proprietary machine interfaces and require different data models and data structures. The packaging plant data communication does not have to worry about such manufacturer-specific or installation-specific influences anymore. A system integrator only has to create a suitable program module for the respective equipment interface and can then access the full range of functions of the packaging plant data exchange. The creation of more complex status data and the calculation of system parameters can also be individually provided in a program module. Status data or status values are accessed via an access interface (preferably only via the access interface) and status data or status values are communicated to the Packaging plant data exchange system via the data input interface (preferably only via the data input interface).

Via the data input interface, the packaging plant data exchange can receive packaging plant status data of equipment/components and/or applications of the packaging plant via the respective adapted program module.

For example, the data input interface of the packaging plant data exchange is arranged to receive packaging plant status data, for example to receive packaging plant status data in a specified data format. This data is made available exclusively via a program module which follows the data conventions of the packaging plant data exchange and is adapted to the respective application area, in particular to an interface of a packaging device.

The fact that the first packaging plant status data represent a first status value of a packaging plant can be understood, for example, as meaning that the first packaging plant status data contain the first status value and/or a representation of the first status value. Furthermore, the first packaging plant status data may contain, for example, metadata describing the first packaging plant status data and/or the first status value. Examples of such metadata include an origin of the first packaging plant status data and/or the first status value, a target of the first packaging plant status data and/or the first status value and/or a unit of the first status value.

A status value of a packaging plant can be understood, for example, as a characteristic value for a current and/or a past condition of the packaging plant and/or a component of the packaging plant. Examples of such a status value are, for example, a measured value recorded by a sensor of the packaging plant and/or a component of the packaging plant and/or a key figure of the packaging plant and/or a component of the packaging plant such as a line and/or component performance (e.g. packaging/hour) and/or an Overall Equipment Effectiveness (OEE). This can also be understood as plant parameters.

The at least one first status value represented by the first packaging plant status data is stored, for example, in a database (a persistent memory) that does not need to be part of the packaging plant data communication. For example, the persistent memory is part of a database system different from the packaging plant data exchange. The persistent memory serves, for example, for the permanent storage of the status values obtained by the packaging plant data exchange. For example, historical and current status values for various states of the packaging plant are stored in the persistent memory. A current status value is to be understood as a value representative of a current condition of the packaging plant. This is, for example, the status value for this state, which is represented by packaging plant status data that was last received for this state by an instance of the packaging plant data exchange. A status value can also be calculated and provided by a program module in particular. Accordingly, a historical status value for a condition is, for example, a status value represented by packaging plant status data that was previously received (i.e., before the last packaging plant status data received for that condition) by the packaging plant data exchange. Status values can be stored in a status date (variable). Current and historical status values can be stored. It can be useful if status values are stored in a temporal sequence, especially serially one after the other.

The packaging plant data exchange provides a data storage interface for communicating with the persistent memory. It is understood that the packaging plant data exchange communicates through the data storage interface with the persistent storage via a database module (e.g. send data and/or values to be stored to the persistent storage and/or receive storage error and/or storage confirmation notifications from the persistent storage).

By adapting the database module to a persistent memory, it is achieved that the packaging plant data exchange can work with different data storages, whereby one database can be addressed by a database module adapted for this purpose. The database module can communicate with a standardized data storage interface. This data storage interface can be identical for all types of database modules. On the other hand, a database module can be configured for one database at a time. It was recognized that different databases make their data available or read in in very different ways via partly proprietary interfaces and require different data models and data structures. The packaging plant data communication does not have to worry about such manufacturer-specific or installation-specific influences anymore. A system integrator only has to create a suitable database module for the respective database and can then access the full range of functions of the packaging plant data exchange.

Storing the at least one first status value represented by the first packaging plant status data in the persistent memory by a data storage interface of the packaging plant data exchange can be understood, for example, that the data storage interface of the packaging plant data exchange communicates the first status value to the persistent memory via the database module for storage in the persistent memory.

With the help of the packaging plant data exchange according to the subject matter, data consistency is ensured for all connected equipment/components and applications. It is ensured that status data is reliably accessible and that a high level of data security is guaranteed. In addition, it is ensured that a uniform data structure and central data storage ensure that the entire packaging plant and all facilities/components and applications working with it always have the same database. Memory and access conflicts are prevented. It also prevents status data from being stored inconsistently.

According to an embodiment, it is proposed that the packaging plant data exchange has an access interface. Via the access interface, program modules can access data within the packaging plant data exchange. Access here is preferably read-only. The status data, in particular the status values, can be called up via the access interface. The access interface also enables the program modules to subscribe to certain status data. The access interface then automatically signals the direction of the program modules when corresponding status data or status values are changed.

Status data within the Packaging plant data exchange can be uniquely identified. For this purpose, metadata can be used to identify criteria (unique criteria) that uniquely identify the status data, for example. Such a unique criterion can be a name and a data source within the metadata. The Packaging plant data exchange ensures data consistency. Using the access interface, program modules can subscribe to access to status data. For this purpose, program modules can log on to the access interface via subscription for a specific status date. Subsequently, the access interface or the packaging plant data exchange monitors whether anything changes on this status date and the subscribing program module is informed of such a change via the access interface.

The status value of the changed status date can be read out via the program module either via the access interface or via a buffer memory interface on the buffer memory. The buffer interface allows access to the buffer by the program modules. This access is preferably read-only, but can also be write. If we are talking about the read interface below, this can mean the buffer interface.

To ensure that the buffer, the data input interface, the data storage interface and preferably the access interface can access the status data reliably and unambiguously, they shall form a common switching network. Furthermore, in order to ensure that data within the packaging plant data exchange can only be changed via the above interfaces, it is proposed that a program module can only exchange status data with the packaging plant data exchange via the switching network.

The program modules are preferably transparent to each other and cannot communicate with each other. Rather, all communication takes place exclusively via the packaging plant data exchange and in particular exclusively via the data input interface and the access interface. Consequently, it is also proposed that the buffer, the data input interface and the data storage interface be operated independently of each other. This means that instances of program modules communicate independently of each other via a data input interface and an access interface. Communication between the interfaces preferably takes place exclusively via a message bus. This is integrated in the switching network. Access to one of the interfaces is not immediately noticed by the other interfaces. Each instance of a program module automatically carries out the data communication with the assigned interfaces.

As explained, a program module accesses the status data within the system data transmission via the access interface. In this respect, it is also proposed that the access interface for communication with the program module be set up. The access interface is a defined interface that can be accessed by various program modules. Packaging plant status data can be taken from the data exchange. The access interface also offers the possibility of being informed about changes to status data. For this purpose, the access interface sends information to the program modules connected to the access interface when corresponding data changes occur.

It is also proposed that the data input interface be set up for communication with a program module that determines at least one packaging plant parameter. As already explained, packaging plant parameters such as OEE or other information concerning the packaging plant can be calculated from the packaging plant status data. Each of these calculations requires at least read access to the packaging plant status data. The results of the calculation can be fed into the data transmission system as new packaging plant status data via the data input interface. This means that a program module, which is set up to calculate packaging plant parameters, first reads the status data and then, if a packaging plant status value is changed or calculated, feeds this status value via the data input interface into the packaging plant data exchange.

As already explained, packaging plant status data can be formed from metadata and status values. With the help of the metadata, the status data in particular can be uniquely identified and assigned. The status values then describe certain states, in particular values recorded by sensors or values calculated using algorithms.

It is often necessary for program modules to access packaging plant status data. In order to initiate such an access, the program modules must have knowledge of the packaging plant status data available within the packaging plant data exchange. To make this possible, the cache preferably has a read interface that allows immediate read access to at least the metadata.

In this context it should be mentioned that the read interface of the buffer is preferably set up exclusively for reading metadata. It is preferred that neither reading nor writing access to status values of the status data is possible via the read interface. Via the read interface, for example, a list of all status data can be output depending on a filter. Filter criteria can be defined using metadata, for example. Here, for example, a filter can be placed over the data source via a program module. Subsequently, metadata on all status data that meet a specific filter criterion can be output via the read interface, for example. It should also be mentioned that read access to status values of the status data is also possible via the read interface. Preferably, however, status data can only be fed into the packaging plant data exchange via the data input interface.

According to an embodiment, it is proposed that the access interface monitors data changes in the data storage. As soon as status data changes, especially status values of status data, this information can be detected in the access interface. Program modules connected to the access interface that want to access the changed status data by means of corresponding subscriptions can then be informed by the access interface. What the corresponding program modules then do with this information is preferably incumbent exclusively on the program modules. It would then be conceivable to read access to status values via the access interface or the read interface of the buffer memory using the metadata to identify the status data whose status values are to be read.

According to an embodiment, it is proposed that the availability of packaging plant status data can be queried via the buffer memory. As already explained, the read interface of the buffer memory can be used for this purpose. In particular, metadata of status data can be queried. Write access to both metadata and status values are preferably only possible via the data input interface.

The buffer memory is equipped in such a way that it preferably temporarily stores status data, in particular in the form of a cache. It is not necessary for the buffer memory to hold all status data permanently. In particular, it is possible that the cache only holds metadata in parts. It is also possible that the cache only holds a subset of all available status data or their metadata. It is proposed that, to start the system, the cache preferably retrieves metadata on all available status data from the persistent data store and makes it available for subsequent retrieval by the program modules or within the data brokering. The status values can then be reloaded from the database as required if program modules want to access them.

However, it is also possible that certain status data is not available as metadata or as status values in the buffer. In order to provide the program modules with all available status data, it is proposed that the buffer first searches internally for packaging plant status data when an availability of packaging plant status data is queried. If no information is available internally for a query, i.e. a negative search result is available, the buffer can be arranged in such a way that it searches for corresponding packaging plant status data in the database via the data storage interface. If corresponding status data is found in the database, the metadata for this can preferably first be made available to the buffer via the data storage interface.

According to an embodiment, it is proposed that access to the data storage interface is only triggered by the packaging plant data exchange, whereby access to the data input interface and/or the access interface is triggered via a program module. The data storage interface can preferably only be accessed via the buffer so that consistent data storage in the database is ensured. Read accesses and/or write accesses to status data via the program modules are preferably carried out via the data input interface and/or the access interface.

The program modules cannot communicate with each other. The program modules are transparent to each other. Direct communication between two program modules is prevented. This ensures that any changes to status data are transmitted via the data link.

According to an embodiment, it is proposed that an access interface is set up to receive a unique identifier of a packaging plant date from a program module. As already mentioned, a unique identifier can be a unique identifier. This can consist of metadata of a status date. With the help of the unique identifier, the program module can signal its interest in certain status data at the access interface. If data changes on the corresponding status date, this can be detected by the access interface and signalled to the program module.

For example, the persistent memory is arranged to communicate a corresponding memory confirmation notification to the data storage interface when the at least a first status value represented by the packaging plant status data has been stored in the persistent memory. Further, the persistent memory is arranged to communicate a corresponding memory error notification to the data storage interface when the at least a first status value represented by the packaging plant status data has not been stored in the persistent memory.

According to an embodiment, the persistent memory is set up for the permanent storage of current and historical status values of the packaging plant. As revealed above, the persistent memory will store, for example, historical and current status values for different states of the packaging plant.

According to an embodiment, the packaging plant data exchange is provided by one or more server devices and/or by one or more virtual servers. A packaging plant data exchange is, for example, the part of the packaging plant data exchange provided by a server device or a virtual server.

According to an embodiment, at least one status value of the packaging plant represents a measured value recorded by a sensor of the packaging plant.

For example, the first status value may contain the first measured value and/or correspond to the first measured value. Alternatively or additionally, the first status value can also contain a counter value and/or a logical value, for example. Such a counter value may, for example, represent the frequency that the first measured value was detected by the sensor; such a truth value may, for example, indicate whether the first measured value is greater than a threshold value and/or less than a threshold value and/or equal to a threshold value.

Examples of sensors for recording the first measured value include a temperature sensor, a light barrier sensor, a pressure sensor, a humidity sensor, a camera, a voltage sensor and/or a level sensor.

A computer program may include program instructions that cause a processor to execute and/or control the method in question when the computer program is executed by the processor. Either all steps of the process can be controlled, or all steps of the process can be executed, or one or more steps can be controlled and one or more steps can be executed.

In this specification, a processor shall be understood to include control units, microprocessors, microcontroller units, digital signal processors (DSP), application-specific integrated circuits (ASICs) or field programmable gate arrays (FPGAs).

For example, the computer program can be distributed over a network such as the Internet, a telephone or mobile network, and/or a local network. The computer program can be at least partially software and/or firmware of a processor. It can also be at least partially implemented as hardware.

For example, the computer program may be stored on a computer-readable storage medium, such as a magnetic, electrical, optical and/or other storage medium. For example, the storage medium may be part of the processor, such as a (non-volatile/persistent or volatile) program memory of the processor or part of it. The storage medium can, for example, be an objective or physical storage medium.

A server device may be arranged to execute and/or control the process in question or may include respective means for executing and/or controlling the steps of the process. Either all steps of the procedure in question can be controlled by the means, or all steps of the procedure according to the invention can be executed by the means, or one or more steps can be controlled by the means and one or more steps can be executed by the means. Different steps can optionally be performed or controlled by different means.

A server system comprising a plurality of server devices and/or a plurality of virtual servers may be arranged to execute and/or control the process in question or may include respective means for executing and/or controlling the steps of the process in question. For example, the server devices and/or the virtual servers are set up to jointly execute and/or control the process in question. It is understood that either all the steps of the present procedure are controlled by the means of the server devices and/or the virtual servers, or all the steps of the inventive procedure are performed by the means of the server devices and/or the virtual servers, or one or more steps are controlled by the means of the server devices and/or the virtual servers and one or more steps are performed by the means of the server devices and/or the virtual servers. Different steps can optionally be performed or controlled by different means of different server devices and/or virtual servers. The server devices and/or the virtual servers of the server system may be located in one or more locations. For example, the server devices and/or the virtual servers of the server system form a server cloud and/or a distributed system. Multiple virtual servers can run simultaneously on one server device. A virtual server is the software and/or hardware replica of the hardware architecture of a (physical) server device by the providing server device.

The means of the disclosed server device(s) may include hardware and/or software components. The means may include, for example, at least one memory containing program instructions of a computer program (e.g., the computer program in conformity with the invention) and at least one processor designed to execute program instructions from the at least one memory. Accordingly, at least one server device comprising at least one processor and at least one memory with program instructions should also be understood as revealed, wherein the at least one memory and the program instructions are arranged, together with the at least one processor, to cause the server device to execute and/or control the method according to the invention at least partially (e.g. alone or together with several server devices of the server system).

A system comprising a server device or server system; and a packaging plant according to the subject matter is also disclosed

The embodiments described above should also be understood as being disclosed in all and any combinations with each other.

Further advantageous embodiments can be found in the following detailed description of some embodiments, especially in connection with the figures. However, the figures enclosed with the application are only intended to clarify the scope of protection of the invention and not to determine it. The enclosed drawings are not necessarily true to scale and are merely intended as an example of the general concept of the invention at hand. In particular, features contained in the figures should by no means be regarded as a necessary component.

In the following, the subject matter is explained in more detail using a drawing showing embodiments. In the drawing show:

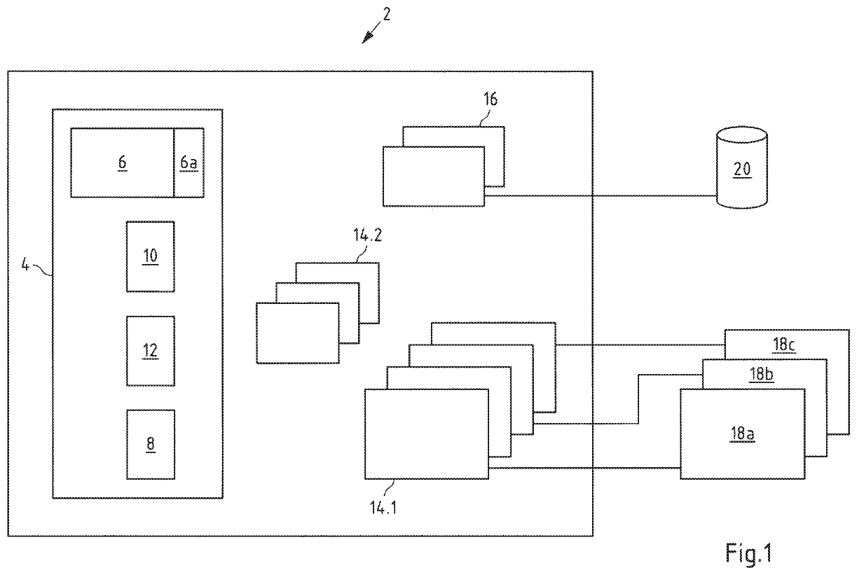

FIG. 1 a packaging plant data exchange according to a design example;

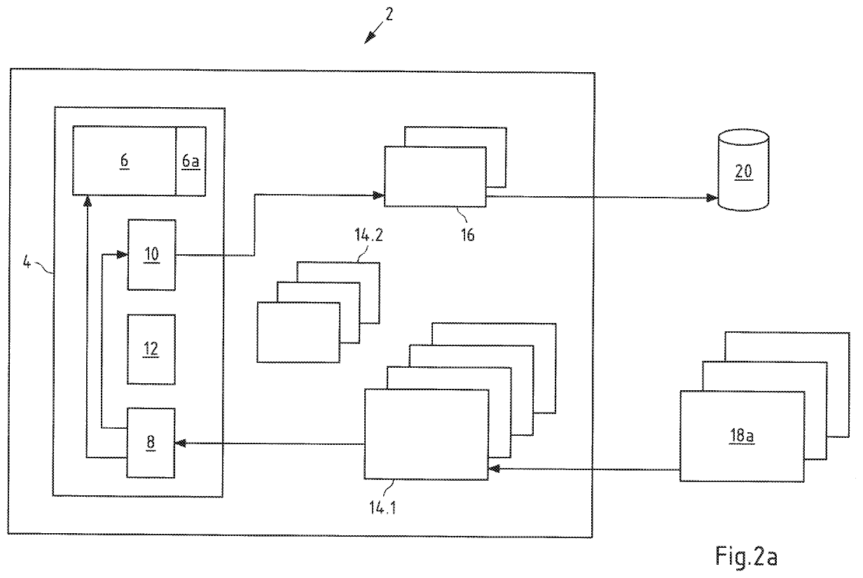

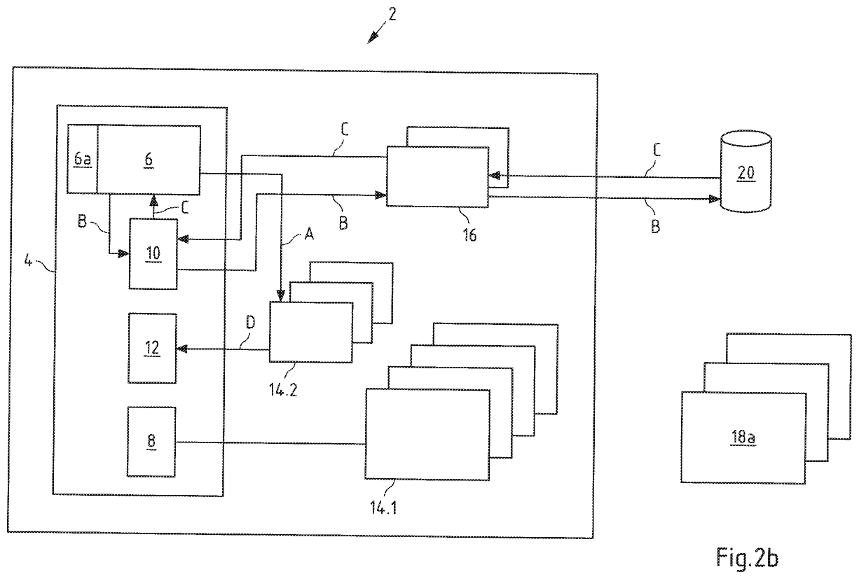

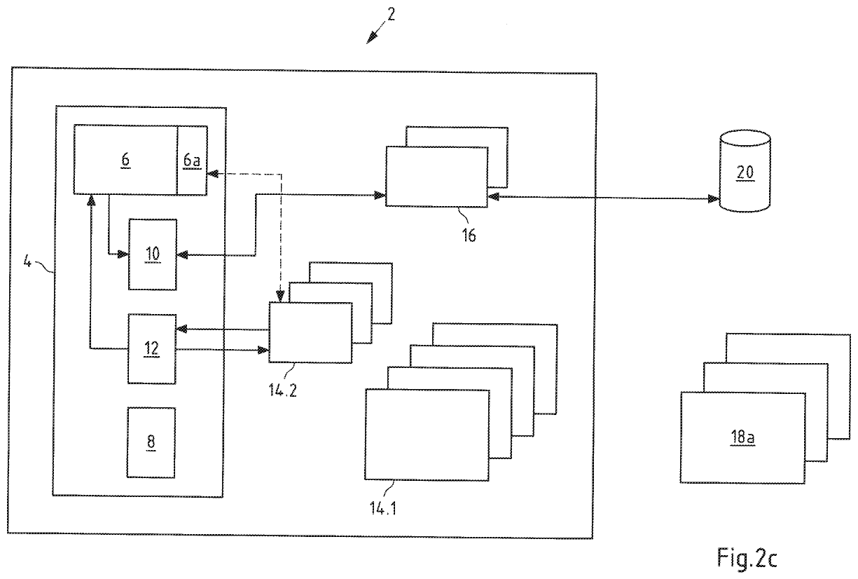

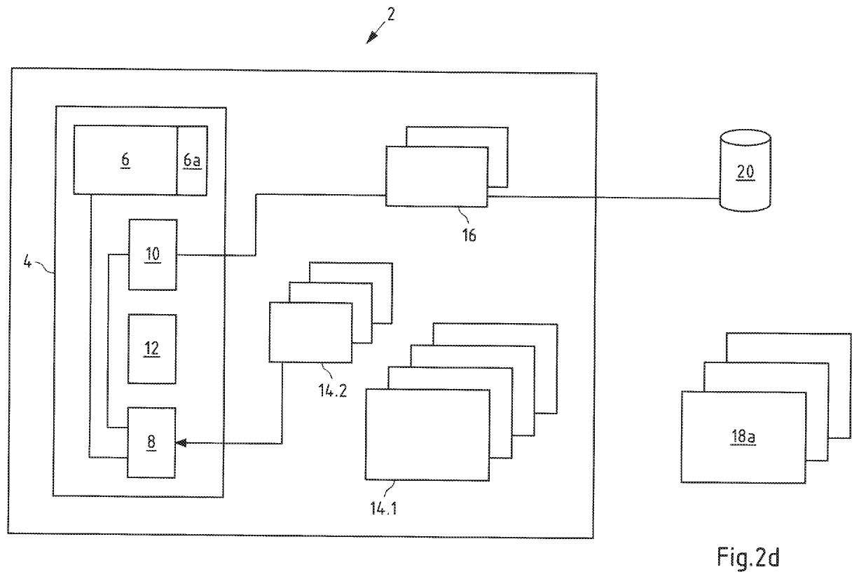

FIG. 2a-d the operation of a packaging plant data exchange with packaging equipment and databases.

The embodiment of the present invention described in this specification should also be understood as being disclosed in all combinations with each other. In particular, the description of a feature covered by an embodiment—unless explicitly stated otherwise—should not be understood in the present case to mean that the feature is indispensable or essential for the function of the embodiment. The sequence of the process steps described in this specification in the individual flow diagrams is not mandatory, alternative sequences of the process steps are conceivable. The process steps can be implemented in different ways, e.g. an implementation in software (by program instructions), hardware or a combination of both to implement the process steps is conceivable. Terms used in patent claims such as “include”, “exhibit”, “include”, “contain” and the like do not exclude other elements or steps. The expression “at least in part” covers both the case “in part” and the case “in full”. The wording “and/or” should be understood as meaning that both the alternative and the combination should be disclosed, i.e. “A and/or B” means “(A) or (B) or (A and B)”. A plurality of units, persons or the like means, in the context of this specification, several units, persons or the like. The use of the indefinite article does not exclude a plurality. A single entity may perform the functions of several entities mentioned in the patent claims. The reference signs indicated in the patent claims are not to be regarded as limitations of the means and steps used.

FIG. 1 shows a packaging plant data exchange 2. Packaging plant data exchange 2 can be executed in a runtime environment, a server, a virtual server or the like. Here, in a switching network 4, which can be part of the packaging plant data exchange 2, a buffer memory 6, a data input interface 8, a database interface 10 and an access interface 12 can be implemented.

In addition, packaging plant data exchange 2 has an environment in which program modules 14.1, 14.2 as well as database modules 16 (or respective instances thereof) can be executed.

It can be seen that the program modules 14.1 can be configured as system program modules 14.1 and can each communicate with a packaging device 18a-c. In addition, a database module 16 can communicate with a database 20. The program modules 14.1 can also be configured as calculation modules and calculate and make available packaging plant parameters, e.g. from status values of the packaging plant.

Program modules 14.1 can be individually adapted to a wide range of packaging devices 18a-c. For example, a packaging device 18a may be a filling device provided by a first manufacturer, whereas a packaging device 18b may be a filling device provided by a second manufacturer. A packaging device 18c, for example, can be a tray packer or another device that can be operated within a packaging plant and that can output status data. The 18a-c packaging devices each have individual interfaces for outputting their status data. The status data can be retrieved from the packaging equipment 18a-c in various data formats via various interfaces and in different ways, so that uniform access to them is impossible. Changes may also occur at the interfaces of the packaging device 18a-c in the course of further developments, which must be mapped.

Program modules 14.1 are provided for this purpose. Each program module 14.1 can be individually adapted for a single 18a-c packaging device. Thus a program module 14.1 can be used to individually access a machine interface of a respective packaging device 18a-c and to read out the status data.

Using a defined data model, program modules 14.1 can output the status data received from the packaging equipment 18a-c as packaging plant status data. Both metadata and status values can be made available in a uniform data format. The data format can define variables, machines or lines. Depending on the data format, the status data can contain metadata and status values. For example, metadata can contain a name, an origin, a target, an origin, synonyms, or tags. This allows the various status data to be described in a uniform data structure.

Using variables, data points, in particular status values of various sensors, can be mapped. Machines can be used to map properties of machines and lines can be used to define links between machines and the layout of the packaging plant.

The uniformly formatted status data can be fed from the packaging equipment 18a-c into the switching network 4 via the program modules 14.1 and the data input interface 8.

The buffer memory 6 can store at least metadata of the status data, but preferably also has sufficient memory to store at least the current status values of status data. For persistent storage, it may be useful to store the status data in a database.

Similar to the packaging devices 18a-c, there are 20 different databases with different database protocols and access interfaces. In order to provide the highest possible flexibility for the packaging plant data exchange 2 or a system integrator, database modules 16 can be provided, which are individualized for each database 20. It goes without saying that both the program modules 14.1 and the database modules 16 must only be made available for the packaging equipment 18a-c and databases 20 available in the packaging plant. Individualisation can be based on the equipment, components and applications available in the packaging plant, so that program modules 14.1 and database modules 16 only have to support what is available.

In addition to the database modules 16 and the program modules 14.1, further program modules 14.2 can be provided with which, for example, information about the packaging plant can be calculated from status values. Such applications can also be provided as program modules 14.2 in packaging plant data exchange 2.

The data with which the program modules 14.1, 14.2, 16 communicate with the interfaces 8, 10, 12 and the buffer memory 6 can, for example, comply with the OMAC PackML standard or the Weihenstephan standard.

The program modules and/or the packaging plant data communication can provide an implementation of a data input interface. In particular, the Packaging plant data exchange may provide data input interfaces as functions, methods and/or classes. It may be possible for an instance of a program module to use a data input interface for communication.

Various additional functions can be made available within the switching network 4. For example, a safety function can be provided. This can be used to monitor write/read rights for various status data. It can be monitored which of the interfaces 8-12 can access status data. It is also possible to monitor which of the program modules 14.1, 14.2 can access data. Furthermore, a user management system is available with which access rights can be assigned to users and users can log in or log out. In addition, a logbook function can be provided for logging actions within the exchange network 4. In addition, standard functionalities can be provided, such as handling exceptions, loading program modules, debugging or the like.

FIG. 2a-d show how packaging plant status data is processed in plant data exchange 2.

After program modules 14.1 and database modules 16.1 have been implemented and/or instantiated and have logged on to the exchange network 4, they have access at least to the data input interface 8, the access interface 12 and the data storage interface 10 and/or, if applicable, the buffer memory 6 or the buffer memory interface 6a. The database module 16.1 preferably has access to the buffer memory 6 via the data storage interface 10. The program modules preferably have access to the buffer memory 6a via the buffer memory interface 6a, in particular read access.

If a machine parameter changes on a packaging device 18a, this can be registered by an appropriate sensor. The packaging machine 18a outputs the changed machine parameter, as shown in FIG. 2a, as a status value at its possibly proprietary machine interface.

Program module 14.1 is arranged to work with packaging device 18a. Program module 14.1 knows the machine interface of the packaging device 18a and can interpret the information accumulated there.

The program module 14.1 converts the received data into a data format for the packaging plant data exchange 2. In this data format, the data is preferably according to the OMAC PackML standard comprehensive metadata and status values. The data processed in this way are communicated from the program module 14.1 to the data input interface 8.

The data input interface 8 signals the program module 14.1 that the data has been received. In addition, information is transmitted from the data input interface 8 to the buffer memory 6. The buffer 6 checks whether information is already stored for this status date or not. If the status data are new, they are stored in the buffer 6 for the first time, if the status data are only value changes of known status data, these value changes are stored in the buffer 6.

In addition, the data storage interface 10 is used to store data in the database 20. For this purpose, the metadata as well as the status values are transferred from the data storage interface 10 in a uniform data structure to the database module 16.

The database module 16 is set up to communicate with a particular database 20 and transfers the corresponding data to the database 20 in the format suitable for the database 20. Thus the modified data are persisted by the packaging device 18a in the database 20 and are also stored in the buffer 6 for retrieval.

It can be seen that no direct communication between the database module 16 and the program module 14.1 is necessary for storing the data. It can also be seen that communication takes place exclusively via interfaces 8-12. The data input interface 8 is triggered by the program module 14.1, whereas the data storage interface 10 is triggered by the switching network 4.

FIG. 2b shows an example of how a program module 14.2, which, for example, evaluates machine parameters, can obtain information on the packaging plant data. In step A, a program module 14.2 can first request information on available packaging plant data via the buffer interface 6a of the buffer 6. The corresponding filter criteria can be specified by the program module 14.2. The query can preferably be based on metadata. The data format used in Packaging plant data exchange 2 is also used here.

In the buffer 6 such a request can first be processed internally. Here it can be checked in the buffer 6 whether corresponding data matching the query are available in the buffer 6. This internal search can only contain a search for metadata or can also retrieve status values.

In addition, in step B, the buffer 6 can check the presence of status values that match the filter set by program module 14.2 in step A via the data storage interface 10 in database 20. The corresponding data can then be transferred in step C from database 20 to buffer 6.

Preferably, the program module 14.2 receives information, in particular metadata on the available status data corresponding to the search query, from the buffer interface 6a. In the program module 14.2 a corresponding status date can then be selected and a subscription to this status date can be set in step D via the access interface 12. The program module 14.2 communicates the metadata, in particular a unique identifier of the date to be monitored, to the access interface 10. With the aid of the method described in FIG. 2b, each program module 14.2 can also retrieve a program module 14.1 of available status data and, by using a unique criterion which uniquely identifies status data, justify the interest in this data at the access interface 10.

FIG. 2c shows a data run if a status date has been changed according to the sequence in FIG. 2a and a program module 14.2 has subscribed to the corresponding status data at the access interface 12.

After a status value has been stored in the database 20 in the method according to FIG. 2a, the access interface 12 signals that a corresponding date has been changed. This signalling by the access interface 12 is performed for each program module 14.1, 14.2 that has registered interest (subscription) in the status date for the access interface 12.

The access interface 12 thus triggers all program modules 14.1, 14.2 that have an interest in a certain status date.

If the program module 14.2 detects that the status date has changed, status values can be retrieved. Two different options are possible.

On the one hand, it is possible for the program module 14.2 to retrieve 12 status values from the corresponding date after signalling a changed value via the access interface. Subsequently, the current status values are loaded from the buffer memory 6 by the access interface 12 and transmitted to the program module 14.2 via the access interface 12.

Here it is conceivable that if there is only one current value in the buffer memory 6, the buffer memory 6 also loads historical status values from the database 20 via the data storage interface 10 using the database module 16 and communicates them to the program module 14.2 via the access interface 12.

Another possibility is the direct access of the program module 14.2 to the buffer 6 via the buffer interface. The program module 14.2 can use the unique criterion to access a status date. Here, too, the buffer memory 6 can either provide locally, internally stored data, in particular status values, via a read interface, or alternatively or cumulatively query the database 20 via the data storage interface 10 and the database module 16 and, if necessary, also read out historical status values. These can then be made available to the program module 14.2.

It should be noted that access to cache 6 via program modules 14.1, 14.2, if immediate, can be read-only.

After a plant parameter has been calculated in a program module 14.2, the program module 14.2, as shown in FIG. 2d, can feed this changed plant parameter back into the system via the data input interface 8. The system parameter calculated by the program module 14.2 is transferred to the data input interface 8 in the uniform data format. From there, the value of the changed data is stored in the buffer 6 and in the database 20, as already shown for another status date in FIG. 2a.

1. A packaging plant data exchange comprising,
at least one buffer for packaging plant status data comprising status values,
at least one data input interface,
the packaging plant data exchange is arranged for communicating via the data input interface with at least one program module adapted to a packaging device of the packaging plant and for receiving at least packaging plant status data, wherein the data input interface is arranged for receiving, packaging plant status data,
at least one data storage interface, wherein
the packaging plant data exchange is arranged for communicating via the data storage interface with at least one database module adapted to a database
characterized in that
an access interface is arranged for communicating with the program module,
the access interface is arranged for accessing packaging plant status data.

2. The packaging plant data exchange according to claim 1,
characterized in that
the buffer, the data input interface, the data storage interface and preferably an access interface form a common switching network, and in that program module exchanges packaging plant status data with the packaging plant data exchange exclusively via the switching network.

3. The packaging, plant data exchange according to claim 1,
characterized in that
the buffer, the data input interface, the data storage interface and preferably an access interface are operated independently of one another and/or in that the buffer, the data input interface and the data storage interface devices are connected to one another via a common message bus which is preferably integrated in the packaging plant data exchange system.

4. (canceled)

5. The packaging plant data exchange according to claim 1,
characterized in that
the data input interface is set up for communication with at least one program module which determines packaging plant parameters and/or in that an instance of a program module respectively implements a data input interface and/or in that the packaging plant data exchange implements a data input interface.

6. The packaging plant data exchange according to claim 1,
characterized in that
the buffer for exchanging packaging plant status data comprising metadata and status values is formed via the data storage interface.

7. The packaging plant data exchange according to claim 1,
characterized in that
the buffer has a buffer interface, in particular a read interface, the buffer interface being set up for at least one direct read access and/or write access to at least metadata in the buffer by at least one program module.

8. The packaging plant data exchange according to claim 1,
characterized in that
the access interface outputs at least one change message, in particular a change message to a program module, in the event of data changes in the packaging plant data exchange, in particular the buffer memory.

9. The packaging plant data exchange according to claim 1,
characterized in that
program modules receive change messages via the access interface in the event of status changes in packaging plant status data in the packaging plant data exchange.

10. The packaging plant data exchange according to claim 1,
characterized in that
program modules directly access the buffer for querying the availability of packaging plant status data, program modules accessing status values and/or metadata of the packaging plant status data via the buffer interface and/or preferably an access interface.

11. The packaging plant data exchange according to claim 1,
characterized in that
when an availability of packaging plant status data is queried, the buffer first searches internally for packaging plant status data and, if the search result is negative, it then searches in the database via the data storage interface for packaging plant status data.

12. The packaging plant data exchange according to claim 1,
characterized in that
accesses to the data storage interface are triggered only by the packaging plant data exchange and/or in that accesses to the data input interface and/or the access interface are triggered via a program module.

13. The packaging plant data exchange according to claim 1,
characterized in that
direct communication is prevented between at least two of the program modules and/or in that at least two of the program modules are anonymous to one another.

14. The packaging plant data exchange according to claim 1,
characterized in that
an access interface is set up to receive a unique identifier of a packaging plant status date from a program module and to signal data changes from packaging plant status data having the unique identifier to the program module.

15. The packaging plant data exchange according to claim 1,
characterized in that
the packaging plant data exchange is provided by one or more server devices and/or by one or more virtual servers.

16. The packaging plant data exchange according to claim 1,
characterized in that
the at least one first status value of the packaging plant represents a first measured value detected by a sensor of the packaging plant.

17. A method comprising:
receiving first packaging plant status data via a data input interface of a packaging plant data exchange, wherein the first packaging plant status data represent at least one first status value of a packaging plant;
storing and/or effecting storage of the at least one first status value represented by the first packaging plant status data in a database by a data storage interface of the packaging plant data exchange; wherein
at least one program module adapted to a packaging device of the packaging plant communicates via the data input interface, and
the data storage interface communicates with at least one database module adapted to the database,
characterized in that
an access interface communicates with the program module,
accessing packaging plant status data via the access interface.

18. The method according to claim 17,
characterized in that
that the database is set up for the persistent storage of current and historical packaging plant status data.

19. The method according to claim 17 further comprising:
detecting at least the first measured value by a sensor of the packaging plant; and
communicating and/or effecting the communication of packaging plant status data to the data input interface via a program module.

20. A computer program comprising program instructions that cause a processor to execute and/or control the method according to claim 17 when the computer program is executed by the processor.

21. A server device or server system comprising a plurality of server devices and/or virtual servers arranged to execute and/or control the process according to claim 17.
